(19) United States
(12) Patent Application Publication
(10) Pub. No.: US 2010/0143704 A1
(43) Pub. Date: Jun. 10, 2010

(54) METAL COMPOSITE MATERIAL AND PROCESS FOR PRODUCING METAL COMPOSITE MATERIAL

(75) Inventors: Makoto Fujita, Anjo-shi (JP); Kunio Kumagai, Anjo-shi (JP); Masaoki Hashimoto, Aichi-gun (JP); Kazuko Hashimoto, Aichi-gun (JP)

Correspondence Address: DARBY & DARBY P.C., P.O. BOX 770, Church Street Station, New York, NY, 10008-0770, US

(73) Assignee: Central Motor Wheel Co., Ltd, Aichi (JP)

(21) Appl. No.: 12/373,613

(22) PCT Filed: Jun. 20, 2007
(86) PCT No.: PCT/JP2007/062388

§ 371 Date: Jan. 13, 2009

(30) Foreign Application Priority Data
Jul. 13, 2006 (JP) 2006 193226

(51) Int. Cl. B32B 5/16; B22D 19/00; B22D 23/00; B22D 25/06

(52) U.S. Cl. 428/328; 428/539.5; 164/76.1

(57) ABSTRACT

A metal composite material is obtained by casting a melt of a metal and has an outer surface on which aluminum borate particles maintained in a porous form are exposed. Therefore, an oil is allowed to infiltrate the aluminum borate particles on the outer surface, to be retained therein and to ooze out during sliding. As a consequence, the sliding life during which desired sliding properties are maintained can be significantly prolonged. The metal composite material may be produced from a preform obtained by sintering aluminum borate particles covered with electrically neutralized silica and alumina particles which have been formed by mixing a silica sol and an alumina sol with aluminum borate particles in an aqueous solution to cover aluminum borate particles.

### CROSS-REFERENCE TO PRIOR APPLICATION

This is the U.S. National Phase Application under 35 U.S.C. §371 of International Patent Application No. PCT/JP2007/062388 filed Jun. 20, 2007, which claims the benefit of Japanese Patent Application No. 2006-193226 filed Jul. 13, 2006, both of which are incorporated by reference herein. The International Application was published in Japanese on Jan. 17, 2008 as WO2008/007524 A1 under PCT Article 21(2).

### FIELD OF THE INVENTION

The present invention relates to a metal composite material having a metal base material, such as an aluminum alloy, and aluminum borate particles bound to the metal base material, and to a process for producing the metal composite material.

### BACKGROUND

Parts made of a light metal, such as aluminum, having excellent properties such as lightness, high durability and low thermal expansion coefficient tend to be increasingly used for, for example, automobiles for the purpose of improving fuel efficiency and stable running performance thereof. In particular, in those parts such as engine parts which are used in severe conditions, a metal composite material composed of a light metal composited with a reinforcement material such as ceramics is used to achieve further improved lightness, durability, etc.

As a method for producing such a metal composite material, there is a known method in which a reinforcement such as short fibers or particles of metals or ceramics is sintered to form a preform of a determined shape, the preform being subsequently impregnated under pressure with a molten metal by die casting. In molding of the preform, an inorganic binder such as an alumina sol is generally mixed with the reinforcement before sintering. The inorganic binder gels and crystallizes during the sintering and, thus, serves to bind the reinforcement components together.

The preform is formed of a reinforcement such as ceramic short fibers and ceramic particles in order to prevent deformation or breakage thereof by pressure exerted at the time a molten metal is impregnated into the preform under pressure. In Japanese Laid Open Patent Publication No. 2004-263211, for example, there is proposed an aluminum composite material produced by impregnating under pressure a melt of an aluminum alloy into a preform which has been prepared by sintering alumina short fibers and aluminum borate particles.

### SUMMARY OF THE INVENTION

The above-described metal composite material which has improved lightness and excellent durability is also used as a so-called sliding member such as a cylinder or a piston that constitutes an engine. Such a sliding member repeatedly slidingly reciprocates during operation and, therefore, is required to have a long service life (hereinafter referred to as sliding life) during which desired sliding properties are maintained. Therefore, a further improvement of a sliding life during which desired sliding properties are maintained is needed in a metal composite material from which such a sliding member is made.

The present invention is aimed at the provision of a metal composite material capable of maintaining its excellent sliding properties for a long period of time and of a process for producing such a metal composite material.

The present invention provides a metal composite material comprising a metal base material obtained by casting a molten metal, and porous aluminum borate particles bound to the metal base material, the metal composite material having an outer surface on which aluminum borate particles maintained in a porous form are exposed.

The above-described sliding member such as a piston or a cylinder is generally configured to slidingly move in a given lubricant oil. Thus, in order to be satisfactorily used as a sliding member, the metal composite material should exhibit in a given lubricant oil an improved sliding life during which desired sliding properties are maintained. The present inventors have made an earnest study with a view toward achieving such an improvement and, as a result, have reached the constitution of the present invention.

The inventors have found that aluminum borate particles in a porous form have properties of easily absorbing an oil (grease) into the pores thereof and of holding the absorbed oil therein. Since, however, a metal composite material formed of a metal base material and a reinforcement is produced by casting a molten metal as described above, the molten metal would infiltrate into the aluminum borate particles during the casting. Therefore, the pores of the aluminum borate particles are filled with the metal and cannot absorb an oil. Thus, in the conventional constitution of the metal composite, the aluminum borate particles have been merely used for improving the strength and hardness. In contrast, in the metal composite material produced by casting a molten metal has an outer surface on which aluminum borate particles maintained in a porous form are exposed, so that an oil can be absorbed in the aluminum borate particles.

With the above constitution, the oil which has infiltrated into the pores of the aluminum borate particles exposed on the outer surface can be held therein. When a sliding member such as a piston or a cylinder formed from such a metal composite material is brought into contact with a lubricant oil or grease, the lubricant oil infiltrates into the pores of the aluminum borate particles and is held therein. Upon sliding movement of the sliding member, the lubricant oil gradually oozes out. Thus, even when the sliding movement is repeated for a long period of time, the outer surface of the sliding member is prevented from being abraded because of the lubricant oil gradually oozing from the aluminum borate particles. Namely, the desired sliding properties can be maintained so that the sliding life is remarkably prolonged. During the repeated sliding movement for a long period of time, the lubricant oil may gradually deteriorate. However, since a lubricant oil which has not yet deteriorated can gradually ooze out from the aluminum borate particles, the desired sliding properties can be maintained.

When a determined lubricant oil is previously applied onto the outer surface of the metal composite material of the above constitution on which aluminum borate particles are exposed, the lubricant oil is absorbed in the aluminum borate particles and held therein. Thus, the application of the lubricant oil to the outer surface can also stably improve the sliding life in the same manner as described above. Further, the metal composite material to which a lubricant oil has been previously applied may be also used even in an environment where it is not permissive to use a relatively large amount of the lubricant oil. Since the amount of an oil which can be held in the aluminum borate particles is relatively small, the metal composite material may be also used in an environment where a lubricant oil is scarcely used. By so doing, the sliding life may be prolonged. In those instances, the lubricant oil which oozes out from the aluminum borate particles forms an oil film on the outer surface of the metal composite material. Such an oil film of the lubricant oil formed on the outer surface can improve the abrasion resistance of the outer surface so that the sliding life is prolonged and the durability is remarkably improved.

When a sliding member is constituted from the metal composite material, it suffices that the aluminum borate particles are exposed on at least a specific outer surface thereof that serves as a sliding surface in order to obtain the above-described function and effect.

In the metal composite material as described above, there is proposed a constitution in which the metal composite material is molded by impregnating a preform of sintered porous aluminum borate particles with the molten metal under pressure.

The preform of the sintered reinforcement having a predetermined shape is placed in a mold cavity and is impregnated with the molten metal under pressure. In the case of a preform having the above-described conventional constitution, a molten metal infiltrates into pores of aluminum borate particles so that a lubricant oil cannot enter the pores.

In contrast, in the case of the present invention, the metal composite material obtained from the preform has an outer surface on which aluminum borate particles maintained in a porous form are exposed. Therefore, the above-described function and effect of the present invention may be achieved.

The metal composite material formed from the preform may be used as a sliding member, such as a piston or a cylinder of an engine, which is used in a relatively severe environment. Because the sliding life is prolonged and durability is improved, it is expected that the sliding member will be developed to have further lightness and improved strength.

In the metal composite material as described above, there is proposed a constitution in which the porous aluminum borate particles are dispersed in the metal base material and in which the outer surface has been polished so that the aluminum borate particles maintained in a porous form are exposed on the outer surface.

In the above structure, aluminum borate particles maintained in a porous form are exposed on the outer surface by polishing and/or grinding the outer surface. When such a metal composite material is used as the above-described sliding member, the polished outer surface is formed into a sliding surface having a desired shape.

The polishing and/or grinding may be carried out by various methods such as mechanical polishing and/or grinding using a cutter blade or a grinding wheel, chemical polishing and/or grinding using a chemical agent, and combined mechanical-chemical polishing and/or grinding. The term “polishing and/or grinding” as used herein is intended not only to mean the above single polishing and/or grinding procedure such as mechanical polishing and/or grinding or chemical polishing and/or grinding, but also to include machining the outer surface into a predetermined dimension. One preferred example of such machining is to use a cutting blade such as a diamond tip cutting blade.

In the metal composite material as described above, there is proposed a constitution in which the porous aluminum borate particles have a particle diameter in the range of 3 to 100 μm.

The pore diameter of the aluminum borate particles as well as the number of the pores thereof tend to increase with an increase of the particle diameter thereof. The aluminum borate particles having the above particle diameter can sufficiently and stably absorb and retain an oil. Therefore, the above-described function and effect of the present invention can be stably achieved.

When the particle diameter of the aluminum borate particles is less than 3 μm, the pore diameter of the pores thereof becomes so small that the oil absorption efficiency is reduced. Additionally, the number of the pores becomes so small that it is difficult to stabilize the amount of oil to be absorbed and held in the pores.

Since the aluminum borate particles are relatively rigid, the rigidity (strength) thereof increases with an increase of the diameter thereof. Therefore, during sliding movement, the aluminum borate particles tend to scratch a surface with which the particles are brought into sliding contact. For this reason, the particle diameter is desired to be not greater than 100 μm. A particle diameter of greater than 100 μm will damage a cutting blade or a grinding wheel with which the above-described polishing and/or grinding is carried out so that it becomes difficult to perform polishing and/or grinding work in a suitable manner.

The particle diameter of the aluminum borate particles is preferably 10 to 60 μm in order to achieve the above-described function in a more satisfactory manner.

As a process for producing the above-described metal composite material, there is provided according to the present invention a process comprising a mixing step of mixing together porous aluminum borate particles, a silica sol containing negatively charged silica particles and an alumina sol containing positively charged alumina particles in water to obtain an aqueous mixture slurry; a dewatering step of removing water from the aqueous mixture slurry to form a preliminary mixture body; a sintering step of sintering the preliminary mixture body at a predetermined temperature to form a preform; a melt impregnation step of impregnating the preform with a molten metal by pressure casting; and a polishing and/or grinding step of polishing and/or grinding an outer surface of the impregnated preform after the metal has been bound thereto. The silica sol is a colloidal slurry which is an aqueous slurry in which colloidal silica particles are dispersed in a slurry phase (solvent). The alumina sol is similarly a colloidal slurry containing colloidal alumina particles dispersed in a slurry phase.

By the above method in which the preform of a sintered reinforcement is impregnated with the molten metal under pressure, it is possible to obtain a metal composite material having an outer surface on which aluminum borate particles maintained in a porous form are exposed.

In the mixing step of the process of the present invention, a silica sol containing negatively charged silica particles and an alumina sol containing positively charged alumina particles are mixed together. As a result, the charges are transferred between them to form electrically neutralized (charges are lost) silica particles and electrically neutralized alumina particles. The electrically neutralized silica particles and alumina particles flocculate on surfaces of the aluminum borate particles in the aqueous slurry. As a result, the silica and alumina particles cover the aluminum borate particles to close the pores thereof. In this case, the alumina particles, which have a flocculating action, easily flocculate on the aluminum borate particles together with the silica particles. The silica particles which have flocculated on the surfaces of the aluminum borate particles mainly function to cover the surfaces of the aluminum borate particles. The aqueous mixture slurry thus obtained in the mixing step contains the aluminum borate particles which are covered with the electrically neutralized silica particles and alumina particles.

From the obtained aqueous mixture slurry, the preform is prepared through the dewatering step and sintering step. In the preform, the aluminum borate particles are covered with the silica particles and alumina particles. Therefore, when the molten metal is impregnated into the preform under pressure in the melt impregnation step, the melt is prevented from infiltrating into the aluminum borate particles. The pores of the aluminum borate particles after the melt impregnation step remain as they are.

In the polishing and/or grinding step, the outer surface of the impregnated preform is polished so that the silica particles and alumina particles covering the aluminum borate particles exposed on the outer surface are removed to leave the aluminum borate particles maintained in a porous form. Namely, after the polishing and/or grinding step, the aluminum borate particles maintained in a porous form are exposed on the outer surface.

The above process can thus prepare the metal composite material of the present invention. The metal composite material thus produced can achieve the above-described function and effect of the present invention.

In the polishing and/or grinding step, either of the above-described mechanical polishing and/or grinding and chemical polishing and/or grinding may be adopted.

The silica sol which contains the negatively charged silica particles is generally an alkaline slurry, while the alumina sol which contains the positively charged alumina particles is generally an acidic slurry. Thus, the mixing step is suitably carried out in such a manner that the mixing of the silica sol and alumina sol results in neutralization. With this method, when the mixture of the silica sol and alumina sol becomes neutral, most of the silica particles and alumina particles become electrically neutralized. Thus, when the mixed slurry becomes neural, the electrically neutralized silica particles and alumina particles may be judged to have flocculated on surfaces of the aluminum borate particles. In the manufacturing site, therefore, coverage of the aluminum borate particles with the silica particles and alumina particles may be quantitatively controlled by checking whether or not the mixed slurry becomes neutralized. In this regard, it is preferred that neutralization be judged to have been achieved, when a hydrogen ion concentration pH in the range of 5.5 to 8.5 is reached.

In the process for producing a metal composite material as described above, there is proposed a process in which the silica sol is mixed in the mixing step in an amount so that a weight ratio of a total weight of the silica particles to a total weight of the aluminum borate particles is 0.01 or more and 0.30 or less, and the alumina sol is mixed in the mixing step in an amount so that a weight ratio of a total weight of the alumina particles to a total weight of the aluminum borate particles is 0.01 or more and 0.30 or less.

With such a process, entire surfaces of the aluminum borate particles are covered with the electrically neutralized silica particles and alumina particles, so that, in the melt impregnation step, the infiltration of the molten metal into the aluminum borate particles may be surely prevented.

When each of the weight ratio of the total amount of the silica particles and weight ratio of the total amount of the alumina particles is less than 0.01, the surfaces of the aluminum borate particles are not sufficiently covered and, therefore, the molten metal may infiltrate through the uncovered portions into the aluminum borate particles. When the weight ratio is greater than 0.30, the amount of the deposits on the aluminum borate particles is too large to reduce the void space of the preform. This results in a reduction of the impregnation amount of the molten metal and in difficulty in achievement of the desired properties of the metal composite material.

The total amount of the silica particles and the total amount of the alumina particles are preferably 0.03 or more and 0.15 or less in terms of weight ratio thereof to the total weight of the aluminum borate particles for reasons of enhancement of the above-described function and effect.

As another process for producing the above-described metal composite material, there is provided according to the present invention a process comprising a mixing step of mixing together porous aluminum borate particles, a cationic electrolyte solution containing a positively charged electrolyte and a silica sol containing negatively charged silica particles having a particle diameter in the range of 40 to 200 nm in water to obtain an aqueous mixture slurry; a dewatering step of removing water from the aqueous mixture slurry to form a preliminary mixture body; a sintering step of sintering the preliminary mixture body at a predetermined temperature to form a preform; a melt impregnation step of impregnating the preform with a molten metal by pressure casting; and a polishing and/or grinding step of polishing and/or grinding an outer surface of the impregnated preform after the metal has been bound thereto.

In the mixing step of the above process, the cationic electrolyte solution and the silica sol are mixed together so that the charges are transferred between them to form electrically neutralized (charges are lost) silica particles. The electrically neutralized silica particles flocculate on the surfaces of the aluminum borate particles in the aqueous slurry. Thus, the aluminum borate particles are covered with the silica particles and the pores of thereof are closed therewith. The aqueous mixture slurry thus obtained in the mixing step contains the aluminum borate particles which are covered with the electrically neutralized silica particles.

In the preform prepared from the obtained aqueous mixture slurry, the aluminum borate particles are covered with the silica particles. Therefore, when the molten metal is impregnated into the preform under pressure in the melt impregnation step, the melt is prevented from infiltrating into the aluminum borate particles. The pores of the aluminum borate particles remain as they are.

In the succeeding polishing and/or grinding step, the outer surface of the impregnated preform is polished so that the silica particles covering the aluminum borate particles exposed on the outer surface are removed. Thus, after the polishing and/or grinding step, the aluminum borate particles maintained in a porous form are exposed on the outer surface.

The above process can thus prepare the metal composite material of the present invention. The metal composite material thus produced can achieve the above-described function and effect of the present invention.

In the above process, a silica sol containing silica particles having a particle diameter in the range of 40 to 200 nm is used. Such silica particles, when electrically neutralized, can flocculate on and sufficiently cover the surfaces of the aluminum borate particles. As the particle size of the silica particles decreases, the flocculating efficiency thereof decreases and, therefore, it is difficult for the silica particles to deposit on the surfaces of the aluminum borate particles. When the particle diameter of the silica particles is less than 40 nm, the silica particles hardly cover the aluminum borate particles. On the other hand, as the particle diameter of the silica particles increases, the void space in the preform is reduced. When the particle diameter exceeds 200 nm, the void space within the preform tends to be clogged therewith so that the impregnation efficiency of the molten metal is reduced in the melt impregnation step. Therefore, it is difficult to achieve the desired properties of the metal composite material.

It is preferred that the particle diameter of the silica particles contained in the silica sol be 70 to 120 nm since the silica particles having such a particle diameter can flocculate on the surfaces of the aluminum borate particles to sufficiently cover the entire surfaces thereof to surely and stably prevent the infiltration of the molten metal thereinto.

In the above process, as the cationic electrolyte solution containing positively charged electrolyte, an aqueous acidic solution such as an aqueous acetic acid solution or an aqueous hydrochloric acid solution is suitably used. With such an aqueous solution, charges are transferred between the positively charged hydrogen ions and the negatively charged silica particles to electrically neutralize the silica particles.

In the polishing and/or grinding step, either of the above-described mechanical polishing and/or grinding and chemical polishing and/or grinding may be adopted.

In the process for producing a metal composite material as described above, there is proposed a process in which the cationic electrolyte solution is mixed in an amount so that a hydrogen ion concentration pH thereof after having been mixed with the silica sol is 4.5 or higher and 8.0 or lower.

The silica sol which contains the negatively charged silica particles is generally an alkaline slurry, while the cationic electrolyte solution which contains the positively charged electrolyte is generally an acidic slurry. Thus, the mixing step is suitably carried out in such a manner that the mixing of the silica sol and alumina sol results in neutralization. With this method, when the mixture of the silica sol and alumina sol becomes neutral, most of the silica particles become electrically neutralized. Thus, the electrically neutralized silica particles flocculate on surfaces of the aluminum borate particles. By controlling the adding amount of the cationic electrolyte solution such that the resulting mixture of the silica sol with the cationic electrolyte solution becomes neutral, the silica particles contained in the silica sol can be utilized to efficiently cover the aluminum borate particles.

In the above method, it is possible to judge that the electrically neutralized silica particles have covered the aluminum borate particles when the hydrogen ion concentration pH in the range of 4.5 or higher and 8.0 or lower is reached at the time the cationic electrolyte solution is mixed with the silica sol. Thus, in the manufacturing site, coverage of the aluminum borate particles with the silica particles may be quantitatively controlled by checking whether or not the mixed slurry becomes neutralized.

In the process for producing a metal composite material as described above, there is proposed a process in which the silica sol is mixed in the mixing step in an amount so that a weight ratio of a total weight of the silica particles to a total weight of the aluminum borate particles is 0.01 or more and 0.30 or less.

With such a process, entire surfaces of the aluminum borate particles are covered with the electrically neutralized silica particles, so that, in the melt impregnation step, the infiltration of the molten metal into the aluminum borate particles may be surely prevented.

When the weight ratio of the total amount of the silica particles is less than 0.01, the surfaces of the aluminum borate particles are not sufficiently covered and, therefore, the molten metal may infiltrate through the uncovered portions into the aluminum borate particles. When the weight ratio is greater than 0.30, the amount of the deposits on the aluminum borate particles is excessively large to reduce the void space of the preform. This results in a reduction of the impregnation of the molten metal and in difficulty in achievement of the desired properties of the metal composite material.

The total amount of the silica particles is preferably 0.03 or more and 0.15 or less in terms of weight ratio thereof to the total weight of the aluminum borate particles for reasons of enhancement of the above-described function and effect.

In the above-described two processes for producing a metal composite material, there is proposed a method in which porous aluminum borate particles used in the mixing step have a particle diameter in the range of 3 to 100 μm.

In the above method, as the particle size of the aluminum borate particles increases, the pore diameter of the pores thereof as well as the number of the pores thereof tend to increase. The aluminum borate particles having the above particle diameter can sufficiently and stably absorb and retain an oil. Therefore, the above-described function and effect of the present invention can be stably achieved.

When the particle diameter of the aluminum borate particles is less than 3 μm, the pore diameter of the pores thereof becomes so small that the oil absorption efficiency is reduced. Additionally, the number of the pores becomes so small that it is difficult to stabilize the amount of oil to be absorbed and held in the pores.

Since the aluminum borate particles are relatively rigid, the rigidity (strength) thereof increases with an increase of the diameter thereof. Therefore, during sliding movement, the aluminum borate particles tend to scratch a surface with which the particles are brought into sliding contact. For this reason, the particle diameter is desired to be not greater than 100 μm. A particle diameter of greater than 100 μm will also damage a cutting blade or a grinding wheel with which the above-described polishing and/or grinding is carried out so that it becomes difficult to perform polishing and/or grinding work in a suitable manner. Additionally, because the cutting blade or grinding wheel must be replaced within a short period of use, the production costs disadvantageously increase.

The particle diameter of the aluminum borate particles is preferably 10 to 60 μm in order to achieve the above-described function in a more satisfactory manner.

In the above-described two processes for producing a metal composite material, there is proposed a method in which a polymer flocculant is added in the mixing step.

In the above method, the addition of the polymer flocculant can improve the adhesion force between the aluminum borate particles relative to the electrically neutralized silica and alumina particles or electrically neutralized silica particles. As a consequence, during the transportation in each of the process steps, starting from the mixing step to the sintering step, the aluminum borate particles may be stably and surely maintained in the covered state. Namely, in the preform after the sintering step, the covered state of the aluminum borate particles remains unchanged. Therefore, in the succeeding melt impregnation step, the effect of preventing the infiltration of the molten metal into the aluminum borate particles can be obtained in a higher degree.

As the polymer flocculant, polyacrylamide may be suitably used.

### EFFECT OF THE INVENTION

Since the present invention provides a metal composite material which comprises a metal base material molded by casting a molten metal, and porous aluminum borate particles bound to the metal base material, and in which the aluminum borate particles maintained in a porous form are exposed on outer surface thereof, an oil may be absorbed and retained in the pores of the aluminum borate particles maintained in a porous form. Therefore, when a sliding member constituted of the metal composite material is slidingly moved with a lubricating oil being retained in the pores, the lubricating oil gradually oozes out upon the sliding movement, so that wear of the outer surface thereof may be suppressed. Namely, the lubrication life during which the desired sliding properties are maintained may be prolonged. By previously applying a lubricating oil to an outer surface of the metal composite material, the lubricating oil can be retained. Therefore, even when the using amount of the lubricating oil is very small, the sliding life may be prolonged because the lubricating oil retained in the aluminum borate particles can ooze out therefrom.

When the metal composite material as described above is constituted such that the metal composite material is as molded by impregnating a preform of sintered porous aluminum borate particles with the molten metal under pressure, the above-described function and effect can be suitably achieved. Thus, the metal composite material may be used as a sliding member which is used in a relatively severe environment and which has further lightness and improved strength.

When the metal composite material as described above is constituted such that the porous aluminum borate particles are dispersed in the metal base material and the outer surface has been polished so that the aluminum borate particles maintained in a porous form are exposed on the outer surface, an oil may be retained in the aluminum borate particles exposed on the polished outer surface. Thus, when such a metal composite material is used as a sliding member having the polished outer surface as its sliding surface, the above-described function and effect of the present invention may be suitably achieved.

When the metal composite material as described above is constituted such that the porous aluminum borate particles have a particle diameter in the range of 3 to 100 μm, an oil can be sufficiently and stably absorbed and retained therein. Therefore, the above-described function and effect of the present invention can be stably achieved.

As a process for producing the above-described metal composite material, the present invention provides a process comprising a mixing step of mixing together porous aluminum borate particles, a silica sol containing negatively charged silica particles and an alumina sol containing positively charged alumina particles in water to obtain an aqueous mixture slurry; then forming a preform through a dewatering step and a sintering step; a melt impregnation step of impregnating the preform with a molten metal by pressure casting; and a polishing and/or grinding step of polishing and/or grinding an outer surface of the impregnated preform. By this process, the silica particles and the alumina particles which have been neutralized in the mixing step flocculate on and cover outer surfaces of the aluminum borate particles. Therefore, in the melt impregnation step, the molten metal is prevented from infiltrating into the pores of the aluminum borate particles. After the polishing and/or grinding step, the aluminum borate particles maintained in a porous form are exposed on the outer surface. Thus, the above process can produce the above-described metal composite material of the present invention.

When the process for producing a metal composite material as described above is constituted such that the silica sol and the alumina sol mixed in the mixing step are each used in an amount so that a weight ratio of a total weight of thereof to a total weight of the aluminum borate particles is 0.01 or more and 0.30 or less, surfaces of the aluminum borate particles may be sufficiently covered with the electrically neutralized silica particles and alumina particles, so that, in the melt impregnation step, the infiltration of the molten metal into the aluminum borate particles may be surely prevented.

As another process for producing the above-described metal composite material, the present invention provides a process comprising a mixing step of mixing together porous aluminum borate particles, a cationic electrolyte solution containing a positively charged electrolyte and a silica sol containing negatively charged silica particles having a particle diameter in the range of 40 to 200 nm in water to obtain an aqueous mixture slurry; forming a preform through a dewatering step and a sintering step; a melt impregnation step of impregnating the preform with a molten metal by pressure casting; and a polishing and/or grinding step of polishing and/or grinding an outer surface of the impregnated preform. By this process, the silica particles which have been neutralized in the mixing step may flocculate on and cover outer surfaces of the aluminum borate particles. Therefore, in the melt impregnation step, the molten metal is prevented from infiltrating into the pores of the aluminum borate particles. After the polishing and/or grinding step, the aluminum borate particles maintained in a porous form are exposed on the outer surface. Thus, the above process can produce the above-described metal composite material of the present invention.

When the process for producing a metal composite material is constituted such that the cationic electrolyte solution is used in an amount so that a hydrogen ion concentration pH thereof after having been mixed with the silica sol is 4.5 or higher and 8.0 or lower, the slurry after the mixing is neutralized. Therefore, most of the silica particles contained in the silica sol become electrically neutralized. Thus, the aluminum borate particles are efficiently covered with the electrically neutralized silica particles. In the manufacture site, the coverage of the aluminum borate particles with the silica particles can be quantitatively controlled.

When the process for producing a metal composite material as described above is constituted such that the silica sol is used in an amount so that a weight ratio of a total weight of the silica particles to a total weight of the aluminum borate particles is 0.01 or more and 0.30 or less, surfaces of the aluminum borate particles are sufficiently covered with the electrically neutralized silica particles. Thus, in the melt impregnation step, the infiltration of the molten metal into the aluminum borate particles may be surely prevented.

When the above-described processes for producing a metal composite material are each constituted such that the porous aluminum borate particles have a particle diameter in the range of 3 to 100 μm, the produced metal composite material can sufficiently and stably absorb and retain an oil. Therefore, the above-described function and effect of the present invention can be suitably achieved.

When the above-described processes for producing a metal composite material are each constituted such that a polymer flocculant is added in the mixing step, gelled silica particles and alumina particles can cover surfaces of the aluminum borate particles with a sufficiently high adhesion force and can be prevented from being removed from the surfaces. Therefore, the effect of preventing the infiltration of the molten metal into the aluminum borate particles can be further improved.

### BRIEF DESCRIPTION OF THE DRAWINGS

FIG. 1 is a view explanatory of a preform forming step for forming a preform of Example 1.

FIG. 2 is a view explanatory of steps of molding, from the preform formed in the preform forming step, a metal composite material through a die casting step and a cutting work step.

FIG. 3 shows (A) a magnification photograph and (B) a higher magnification photograph of porous aluminum borate particles.

FIG. 4 shows a magnification photograph of aluminum borate particles constituting the preform of Example 1.

FIG. 5 shows (A) a magnification photograph of an outer peripheral surface of a metal composite material molded from the preform and (B) a higher magnification photograph of the aluminum borate particles exposed on the outer peripheral surface.

FIG. 6 shows (A) a magnification photograph of the aluminum borate particles constituting the preform of Example 2 and (B) a magnification photograph of an outer peripheral surface of a metal composite material molded from the preform.

FIG. 7 shows (A) a magnification photograph of the aluminum borate particles constituting the preform of Comparative Example.

FIG. 8 shows (A) a magnification photograph of an outer peripheral surface of a metal composite material molded from the preform and (B) a higher magnification photograph of the aluminum borate particles exposed on the outer peripheral surface.

FIG. 9 shows (A) amass concentration of the metal composite material of Example 1 and (B) a mass concentration of the metal composite material of Comparative Example.

FIG. 10 is a graph, showing the results of measurement of oil retention property of the metal composite materials of Examples and the metal composite material of Comparative Example.

### DETAILED DESCRIPTION OF THE INVENTION

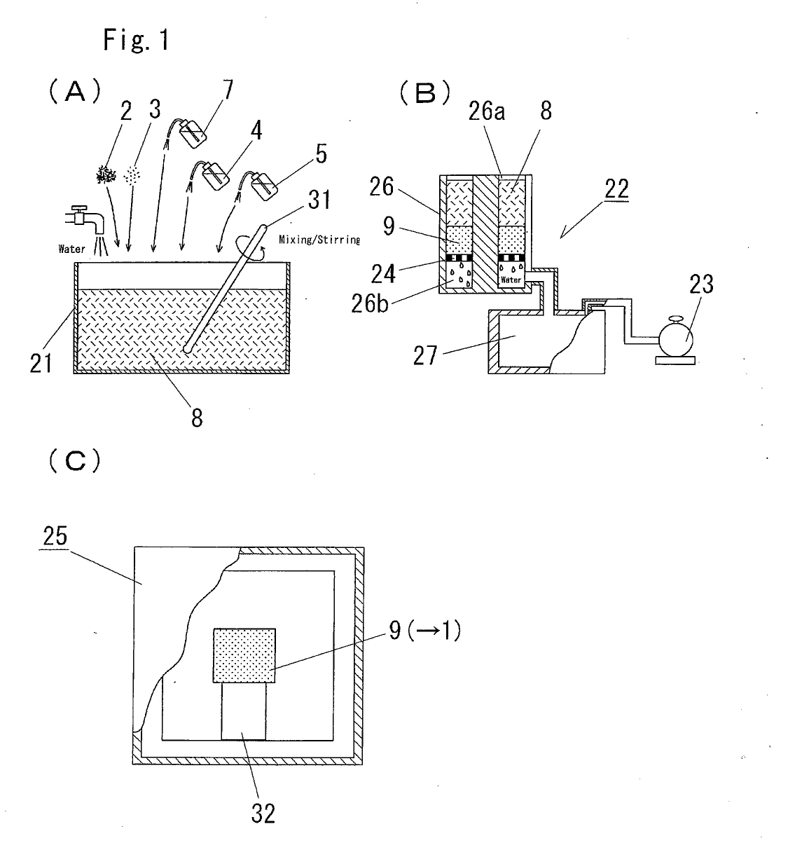

Embodiments of the present invention will be described in detail with reference to the accompanying drawings. FIG. 1 depicts a view illustrating steps for producing a preform 1. The preform producing steps include a mixing step, a dewatering step, a drying step and a sintering step. FIG. 1(A) shows the mixing step in which raw materials are stirred in water contained in a predetermined vessel 21 using a stirring rod 31 and nearly homogeneously mixed to obtain an aqueous mixture slurry 8. The aqueous mixture slurry 8 is then transferred from the vessel 21 to a suction molding device 22. FIG. 1(B) shows the dewatering step in which water of the aqueous mixed slurry 8 is suctioned through a filter 24 by a vacuum pump 23 to produce a preliminary mixture body 9. The preliminary mixture body 9 is taken out of the suction molding device 22 and transferred to the drying step (not shown) for the sufficient drying thereof. FIG. 1(C) shows the sintering step in which the preliminary mixture body 9 is placed on a table 32 within a heating furnace 25 and is heated and sintered at a predetermined temperature to obtain the desired preform 1.

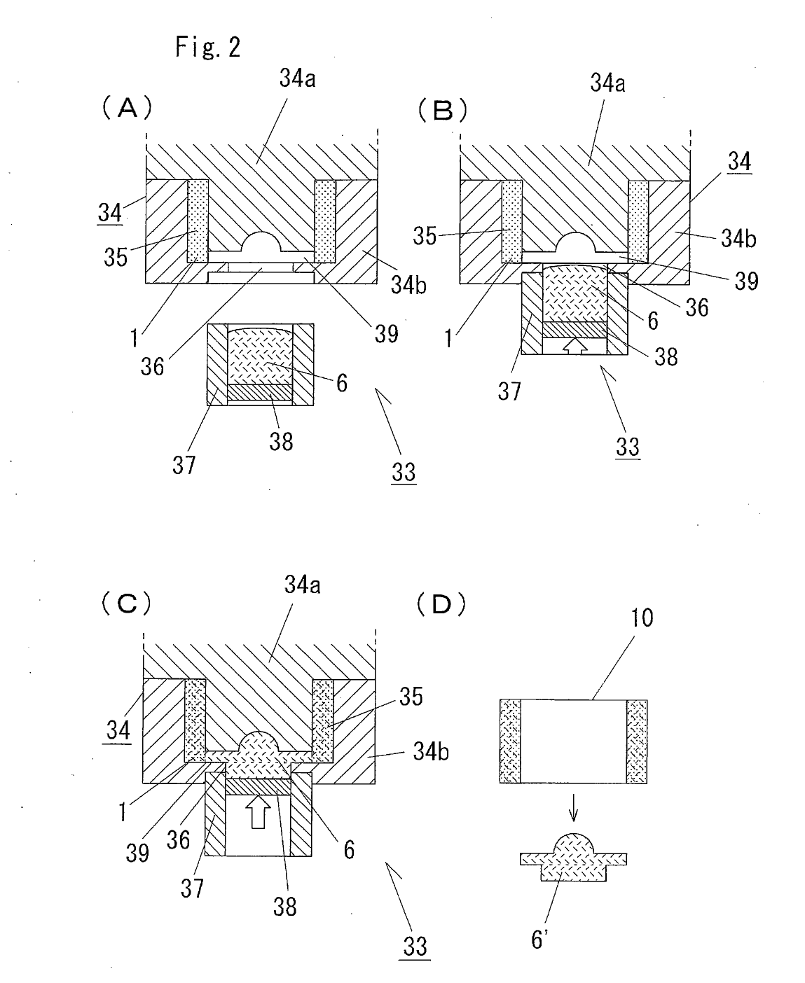

Then, the preform 1 is impregnated with a melt 6 of an aluminum alloy in a die casting step shown in FIGS. 2(A) to 2(C) to produce a metal composite material 10. The die casting step is carried out with a die casting machine 33 which, as shown in FIG. 2(A), includes a mold 34 having a cavity 35 with a predetermined shape, and a sleeve 37 configured to temporarily retain a melt 6 to be injected to the cavity 35 and to inject the melt 6 by the action of a plunger tip 38 adapted to advance and retract within the sleeve 37. The preform 1 is placed within the cavity 35 of the mold 34. The melt 6 to be injected into the cavity 35 is supplied to the sleeve 37 with the plunger tip 38 being maintained in the retracted position. Then, the sleeve 37 is connected to a gate 36 of the mold 34 as shown in FIGS. 2(B) and 2(C). The plunger tip 38 is then driven to the advanced position to inject the melt 6 contained in the sleeve 37 into the cavity 35 to perform pressure casting.

The above die casting step is carried out to impregnate the melt 6 of the aluminum alloy into the preform 1 and constitutes the melt impregnation step of the process of the present invention.

The obtained metal composite material 10 formed in the die casting step is processed to cut its outer surface, namely is subjected to a polishing and/or grinding step to trim the outer surface into a desired shape and dimension. By this step, the metal composite material 10 having the desired shape and dimension is obtained.

A concrete example of the metal composite material 10 produced through a shaping step to obtain a preform 1, a die casting step to impregnate the preform with a melt 6 of an aluminum alloy and a polishing and/or grinding step to mechanically work a product into a desired shape and dimension will be described below.

### Example 1

In the shaping step for forming the preform 1, the following materials (i) to (v) are added to water contained in a vessel 21 and are mixed (mixing step of FIG. 1(A)).

(i) Alumina short fibers 2 (average fiber diameter: 3 μm, average fiber length: 400 μm)
(ii) Aluminum borate particles 3 (9Al₂O₃.2B₂O₃, average particle diameter: 40 μm)
(iii) Silica sol 4 (aqueous colloidal slurry, hydrogen ion concentration pH: 10, concentration: about 40%)
(iv) Alumina sol 5 (aqueous colloidal slurry, hydrogen ion concentration pH: 3, concentration: about 20%)
(v) Polyacrylamide 7 (aqueous solution, concentration: about 10%)

The above average fiber diameter, average fiber length and average particle diameter are average values of the fiber diameters, fiber lengths and particle diameters, respectively, with certain variations. The alumina short fibers 2 and aluminum borate particles 3 are so-called reinforcements, while the silica sol 4 and alumina sol 5 are inorganic binders.

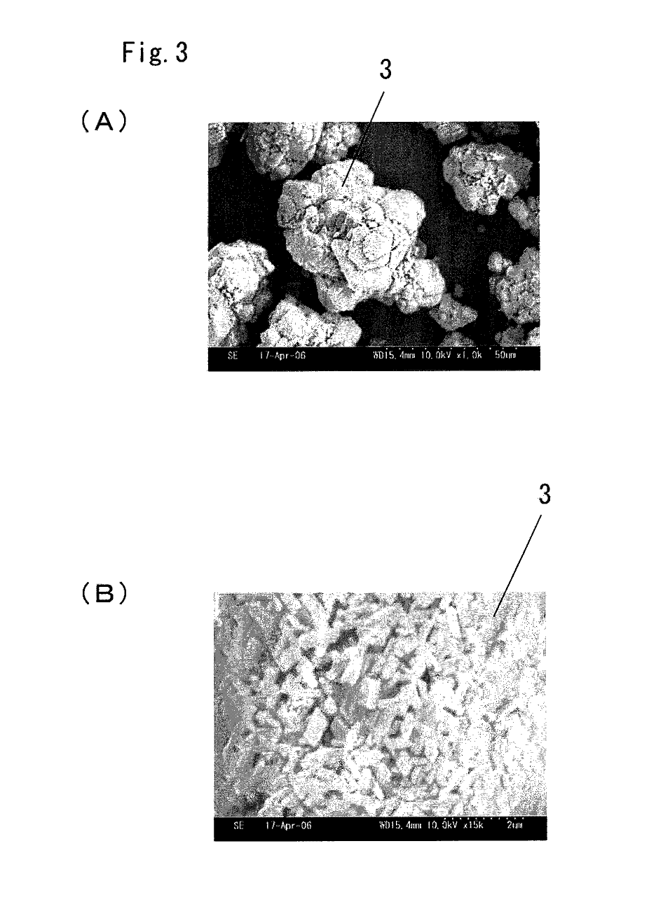

The aluminum borate particles 3 have a large number of fine openings in their surfaces as shown in FIG. 3 with the openings being interconnected within respective particles. Thus the aluminum borate particles 3 are porous in nature.

The amount of the alumina short fibers 2 is adjusted so that the volume fraction thereof is about 10% by volume based on the volume of the preliminary mixture body 9 shaped in the dewatering step and drying step. Similarly, the amount of the aluminum borate particles 3 is adjusted so that the volume fraction thereof is about 8% by volume based on the volume of the preliminary mixture body 9.

The alumina sol 5 is an aqueous colloidal slurry containing positively charged alumina particles having an average particle diameter of 20 nm and is acidic in nature. The silica sol 4 is an aqueous colloidal slurry containing negatively charged silica particles having an average particle diameter of 80 nm and is alkaline in nature. The amount of the acidic alumina sol 5 and the alkaline silica sol 4 is adjusted so that, when they are mixed together, the hydrogen ion concentration pH of the mixture is in the range of 6.0 to 7.0. When neutralization (hydrogen ion concentration pH is 6.0 to 7.0) is achieved as a result of the mixing, the alumina sol 5 and silica sol 4 are judged to be sufficiently mixed with each other so that most of the silica particles and alumina particles become electrically neutralized by transference of the charges therebetween.

The silica sol 4 is added in an amount so that the weight ratio thereof to a total weight of the alumina short fibers 2 and the aluminum borate particles 3 is about 0.20. Thus, the weight of the silica particles contained in the silica sol 4 used is about 0.09 in terms of weight ratio thereof to the weight of the aluminum borate particles 3. On the other hand, the alumina sol 5 is added in an amount so that the weight ratio thereof to a total weight of the alumina short fibers 2 and the aluminum borate particles 3 is about 0.18. Thus, the weight of the alumina particles contained in the alumina sol 5 used is about 0.04 in terms of weight ratio thereof to the weight of the aluminum borate particles 3.

The aqueous slurry containing the above-described materials (i) to (v) is stirred with the stirring rod 31 to obtain an aqueous mixture slurry 8 in which the above materials are nearly homogeneously mixed.

As a result of the stirring, the silica sol 4 and the alumina sol 5 are mixed each other and the charges thereof are transferred therebetween to form electrically neutralized (charges are lost) silica particles and alumina particles. The electrically neutralized silica particles and alumina particles flocculate on surfaces of the aluminum borate particles 3. Thus, the aluminum borate particles 3 are covered with the silica particles and alumina particles so that the pores thereof are closed. Since the alumina particles have flocculating property, the alumina particles properly easily flocculate together with the silica particles on surfaces of the aluminum borate particles 3. On the other hand, the silica particles mainly exhibit the function to cover the aluminum borate particles 3.

Further, because of addition of a very small amount of polyacrylamide 7, the aluminum borate particles 3 and the silica and alumina particles which have flocculated on surfaces thereof are suitably adhered to each other in a stable manner. Since the silica sol 4 and the alumina sol 5 are used in a large amount relative to the aluminum borate particles as described above, the entire surfaces of the aluminum borate particles 3 in the aqueous mixture slurry 8 are covered with the silica and alumina particles.

The aqueous mixture slurry 8 is then transferred to a suction molding device 22 to perform a dewatering step (FIG. 1(B)). The suction molding device 22 includes a cylindrical slurry retaining section 26 having an interior space divided with a filter 24 into an upper region 26a into which the aqueous mixture slurry 8 is supplied and a lower region 26b; a water collecting section 27 provided beneath the slurry retaining section 26 for slurry communication with the lower region 26b of the slurry retaining section 26; and a vacuum pump 23 connected to the water collecting section 27 for suctioning water from the slurry retaining section 26 through the water collecting section 27.

In the dewatering step, after the aqueous mixture slurry 8 has been supplied into the upper region 26a of the slurry retaining section 26 of the suction molding device 22, the vacuum pump 23 is driven to suction water of the aqueous mixture slurry 8 through the water collecting section 27 and the lower region 26b of the slurry retaining section 26. Thus, the water of the aqueous mixture slurry 8 flows down through the filter 24 to obtain a preliminary mixture body 9 in the form of a cylinder composed of a mixture of the above-described materials. The preliminary mixture body 9 is taken out of the suction molding device 22 and placed in a drying furnace at about 120° C. to perform a drying step for sufficiently remove water therefrom.

The preliminary mixture body 9 after the dewatering step is made from the aqueous mixture slurry 8 in which the materials are nearly uniformly dispersed in the mixing step. Therefore, in the preliminary mixture body 9, too, the materials are uniformly dispersed therein. The above-described electrically neutralized silica particles and alumina particles also deposit onto surfaces of the alumina short fibers 2. Therefore, in the preliminary mixture body 9 after the dewatering step, the adjacent alumina short fibers 2 and aluminum borate particles 3 are sufficiently bonded to each other with the silica particles and alumina particles. Thus, the cylindrical preliminary mixture body 9 is prevented from being deformed or broken during its transfer to the heating furnace 25 and the shape of the preliminary mixture body 9 is held unchanged.

Next, the above-described sintering step (FIG. 1(C)) is conducted. The preliminary mixture body 9 is placed on a table 32 disposed within the heating furnace 25 and is heated to about 1,150° C. and maintained at that temperature for about one hour to sinter the alumina short fiber 2 and the aluminum borate particles 3, thereby obtaining a cylindrical preform 1.

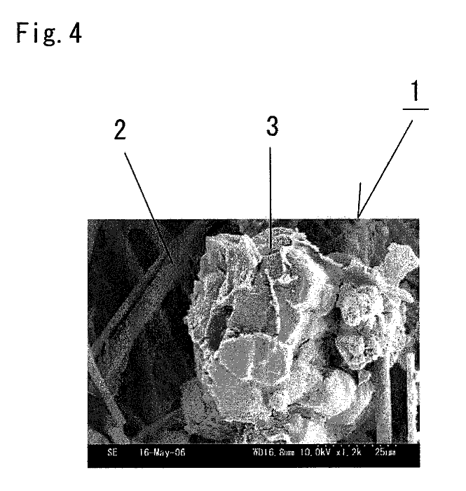

In the preform 1, the adjacent alumina short fibers 2 and aluminum borate particles 3 are relatively strongly bonded to each other with the crystallized silica particles and alumina particles which are deposited on surfaces of the alumina short fibers 2 and aluminum borate particles 3. As shown in FIG. 4, in the preform 1, surfaces of the aluminum borate particles 3 are covered with the crystallized silica particles and alumina particles.

Therefore, pores of the aluminum borate particles 3 are covered.

In the preform 1, the alumina short fibers 2 and aluminum borate particles 3 are nearly uniformly dispersed throughout. Between the alumina short fibers 2 and aluminum borate particles 3 in the preform 1, there are relatively large void space. Therefore, the preform has good air permeability.

In the above-described die casting step (FIG. 2), the preform 1 having the above construction is molded into a metal composite material 10. A die casting machine 33 has a mold 34 composed of an upper mold 34a having a convex shape and a lower mold 34b having a concave shape and is adapted to define a cylindrical cavity 35 into which the cylindrical preform 1 is to be fitted. The lower mold 34b of the mold 34 has a connecting portion (not shown) to which a sleeve 37 is connected and a gate 36 through which a melt 6 contained in the sleeve 37 flows into the cavity 35 when the sleeve 37 is connected to the lower mold 34b. When the upper mold 34a and lower mold 34b are in engagement with each other, there is also defined a runner 39 through which the cavity 35 and the gate 36 are in fluid communication with each other, namely through which the melt 6 introduced from the gate flows into the cavity 35.

In the die casting step, the preform 1 is first pre-heated to about 600° C. while the mold 34 is maintained at 200 to 250° C. Then, as shown in FIG. 2(A), the pre-heated preform 1 is placed in the lower mold 34b with which the upper mold 34a is then brought into fitting engagement so that the preform is accommodated in the cylindrical cavity 35 of the mold 34. The melt 6 of an aluminum alloy maintained at about 680° C. is supplied to the sleeve 37 located beneath the mold 34 with a plunger tip 38 being maintained in a retracted position (not shown). In the present Example, JIS ADC12 is used as the aluminum alloy.

Then, as shown in FIG. 2(B), the sleeve 37 is moved upward to connect an upper end portion of the sleeve 37 to the gate 36 of the mold 34. The plunger tip 38 is driven from the retracted position to an advanced position at a predetermined speed to inject the melt 6 contained in the sleeve 37 into the cavity 35. In this Example, the driving speed of the plunger tip 38 is controlled so that the melt 6 from the gate 36 is injected at an applied pressure of about 500 atm. In a manner as described above, the aluminum alloy melt 6 is impregnated under pressure into the perform 1 disposed within the cavity 35.

As shown in FIG. 2(C), the plunger tip 38 is stopped moving to terminate the injection of the melt 6 when the melt 6 is filled in the cavity 35. After the melt 6 has been cooled, the sleeve 37 is moved downward and disengaged from the mold 34. As shown in FIG. 2(D), the upper mold 34a and lower mold 34b of the mold 34 are separated from each other to take out the metal composite material 10 from the mold 34. The metal composite material 10 is formed of the aluminum alloy 6′ as a base material with which the aluminum short fibers 2 and the aluminum borate particles 3 are composited.

The metal composite material 10 thus formed by the above die casting step is then subjected to a cutting work using a milling machine. In the cutting work step for the metal composite material 10 taken out of the mold 34, those portions thereof which correspond to the gate 36 and runner 39 are removed to obtain a cylindrical form as shown in FIG. 2(D). Further, the outer peripheral surface of the metal composite material 10 is cut to mechanically polish the outer peripheral surface (not shown), so that the metal composite material 10 is trimmed to have the desired shape and dimension. Thus, the cutting work step using the milling machine constitutes the polishing and/or grinding step of the process of the present invention.

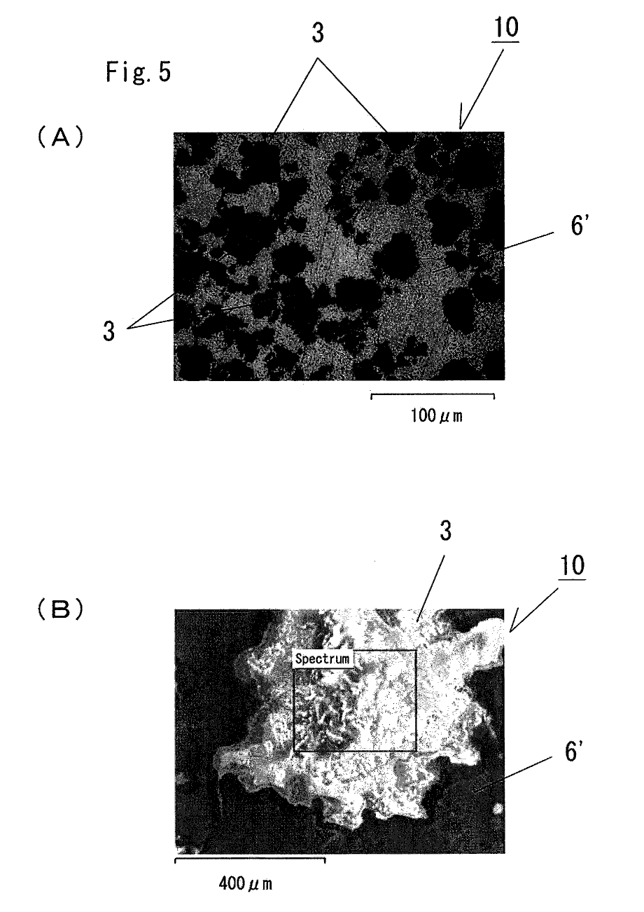

The observation of the outer peripheral surface of the thus obtained metal composite material 10 reveals that, as shown in FIG. 5(A), a large number of pores are present on the aluminum borate particles 3 exposed on the outer peripheral surface. From FIG. 5(B) which show the aluminum borate particles 3 in a higher magnification, it is seen that no aluminum alloy 6′ has infiltrated in the pores of the aluminum borate particles 3. This indicates that the aluminum borate particles 3 maintained in a porous form are exposed on the outer peripheral surface of the metal composite material 10 as shown in FIGS. 5(A) and 5(B).

That is, in the above-described production process, the aluminum borate particles 3 are covered with silica particles and alumina particles which have been electrically neutralized in the mixing step. The aluminum borate particles 3 are still covered as such until after the sintering for the formation of the preform 1. When the preform 1 is impregnated with the aluminum alloy melt 6 under pressure, the impregnated melt 6 is filled in the voids formed between the alumina short fibers 2 and the aluminum borate particles 3. Because the aluminum borate particles 3 are covered as described above during the sintering, the melt 6 cannot infiltrate into the pores of the aluminum borate particles 3. When the outer peripheral surface of the obtained metal composite material 10 is polished by cutting work, those aluminum borate particles 3 which are located on and near the outer peripheral surface of the metal composite material 10 are cut. In the cut aluminum borate particles 3, the silica particles and alumina particles which have covered the aluminum borate particles 3 are cut away so that pores thereof are exposed on the outer peripheral surface. Therefore, the aluminum borate particles 3 maintained in a porous form are exposed on the outer peripheral surface of the metal composite material 10.

In the metal composite material 10 of Example 1 is sufficiently impregnated with the aluminum alloy 6′ and is free of mold cavities (unimpregnated regions) as shown in FIG. 5. Further, none of cracks or fractures are formed in the metal composite material 10. Accordingly, it is understood that the preform 1 has excellent air permeability as well as strength enough to withstand the impregnation of the melt 6 under pressure.

In Example 1, the desired metal composite material 10 is produced by polishing and/or grinding the cylindrical outer peripheral surface. The polished outer peripheral surface is “outer surface” according to the present invention.

### Example 2

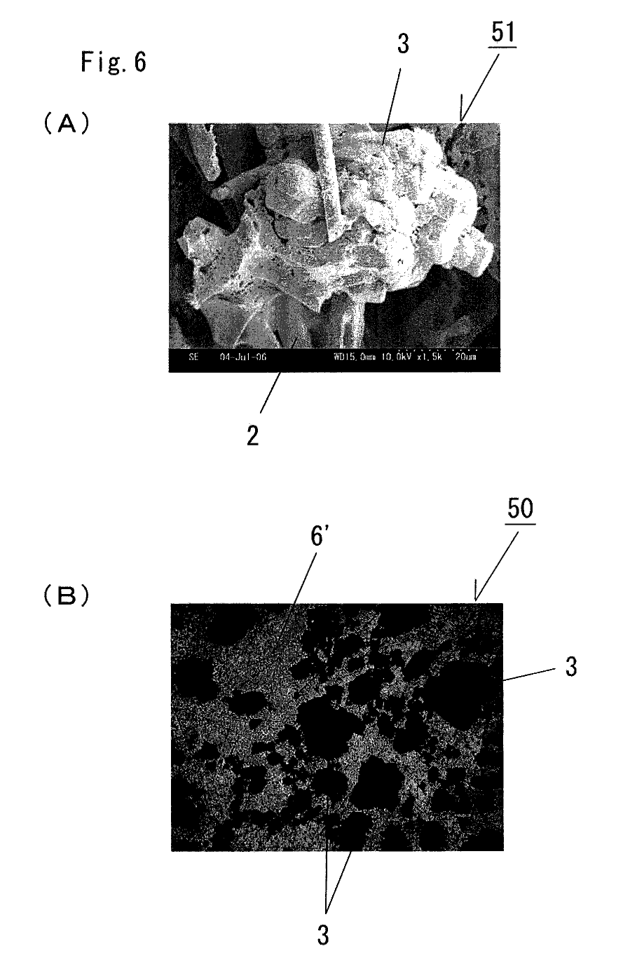

In Example 2, an acetic acid solution was used in place of the alumina sol 5 in the mixing step. After formation of a preform 51 (see FIG. 6(A)), a melt 6 of an aluminum alloy was impregnated into the preform 51 to form a metal composite material 50 (see FIG. 6(B)). The preform 51 and the metal composite material 50 are produced by the same preform shaping step, die casting step and cutting work using a milling machine (polishing and/or grinding step) as those in Example 1.

In the mixing step (see FIG. 1(A)), the following materials (i) to (v) are added to water contained in a vessel 21.

(i) Alumina short fibers 2 (average fiber diameter: 3 μm, average fiber length: 400 μm)
(ii) Aluminum borate particles 3 (9Al₂O₃.2B₂O₃, average particle diameter: 40 μm)
(iii) Silica sol 4 (aqueous colloidal slurry, hydrogen ion concentration pH: 10, concentration: about 40%)
(iv) Aqueous acetic acid solution (aqueous acidic solution, hydrogen ion concentration pH: 3, concentration: about 10%)
(v) Polyacrylamide 7 (aqueous solution, concentration: about 10%)

The kind and amount of the above alumina short fibers 2 and aluminum borate particles 3 are the same as those in Example 1. The kind and amount of the silica sol 4 (containing negatively charged silica particles having a particle diameter of 80 nm) is also the same as those in Example 1. Further, the polyacrylamide 7 is the same as that in Example 1.

The above aqueous acetic acid solution contains positively charged hydrogen ions. Thus, in Example 2, the aqueous acetic acid solution is “cationic electrolyte solution” according to the present invention. The addition amount of the aqueous acetic acid solution is controlled so that the aqueous slurry obtained by mixing the silica sol 4 with the aqueous acetic acid solution has a hydrogen ion concentration pH of in the range of 5.0 to 6.0.

In the mixing step, the silica sol 4 and the aqueous acetic acid solution are mixed with each other so that the charges thereof are transferred therebetween to form electrically neutralized silica particles. The electrically neutralized silica particles flocculate on and cover surfaces of the aluminum borate particles 3. Thus, in the aqueous mixture slurry formed in the mixing step, the aluminum borate particles 3 are present in a form covered with the silica particles.

After the mixing step, a dewatering step, a drying step and a sintering step are successively carried out in the same manner as that in Example 1 (see FIG. 1) to obtain the preform 51 (see FIG. 6(A)). In the preform 51, the surfaces of the aluminum borate particles 3 are covered with the crystallized silica particles so that the pores of the aluminum borate particles 3 are covered as shown in FIG. 6(A).

In the preform 51, the adjacent alumina short fibers 2 and aluminum borate particles 3 are relatively strongly bonded to each other with the crystallized silica particles which are deposited on surfaces of the alumina short fibers 2 and aluminum borate particles 3. The alumina short fibers 2 and aluminum borate particles 3 are nearly uniformly dispersed throughout similar to the preform of Example 1. Between the alumina short fibers 2 and aluminum borate particles 3 in the preform 1, there are relatively large void space. Therefore, the preform 51 has good air permeability.

Using the thus prepared preform 51, the metal composite material 50 is formed in a die casting step by impregnation with a melt 6 of an aluminum alloy in the same manner as described above (FIG. 2). The applied pressure for the impregnation of the melt 6 is the same as that in Example 1. The obtained form is then subjected to cutting work using a milling machine to cut and polish the outer peripheral surface thereof so that the cylindrical metal composite material 50 having the same dimension and shape as that of Example 1 is obtained. The obtained metal composite material 50 is a composite of the aluminum alloy 6′ with the aluminum short fibers 2 and the aluminum borate particles 3. As shown in FIG. 6(B), the aluminum borate particles 3 maintained in a porous form are exposed on the outer peripheral surface of the metal composite material 50. This is because, likewise in Example 1, the melt 6 was not able to infiltrate, in the die casting step, into the aluminum borate particles 3 which had been covered with the silica particles in the mixing step.

In Example 2, the metal composite material 50 is prepared in the same manner as that in Example 1 except for using the aqueous acetic acid solution in the mixing step as described above. Thus, in the above description, explanation of the same steps is omitted and similar component parts are designated as the same reference numerals.

### Comparative Example

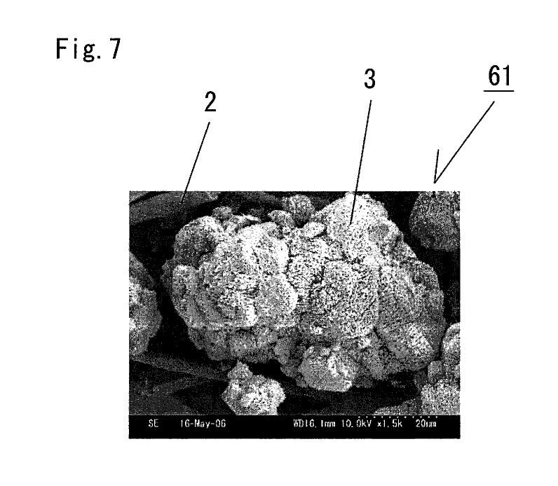

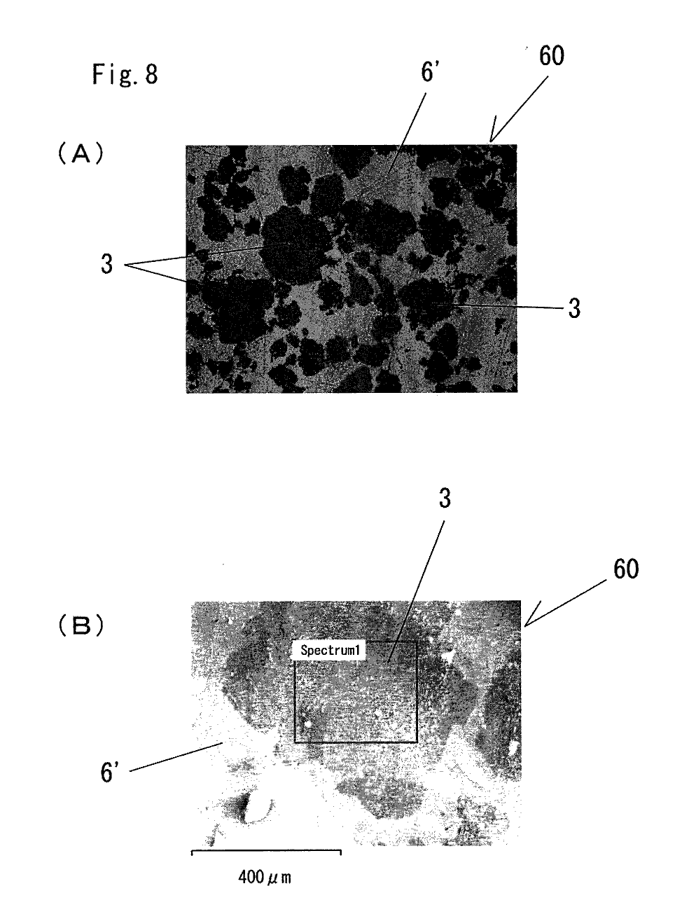

For the purpose of comparison with above Example 1 and Example 2, a conventional preform 61 (see FIG. 7) was prepared in Comparative Example 1 using the silica sol 4 by itself in the mixing step. The preform 6 was impregnated with a melt 6 of an aluminum alloy to form a metal composite material 60 (see FIG. 8). The preform 61 and the metal composite material 60 are produced by the same preform shaping step, die casting step and cutting work using a milling machine (polishing and/or grinding step) as those in Example 1.

In the mixing step (see FIG. 1(A)), the following materials (i) to (iii) in water are stirred in a vessel 21 to obtain an aqueous mixture slurry (not shown).

(i) Alumina short fibers 2 (average fiber diameter: 3 μm, average fiber length: 400 μm)
(ii) Aluminum borate particles 3 (9Al₂O₃.2B₂O₃, average particle diameter: 40 μm)
(iii) Silica sol 4 (aqueous colloidal slurry, hydrogen ion concentration pH: 10, concentration: about 40%)

The kind and amount of the above alumina short fibers 2 and aluminum borate particles 3 are the same as those in Example 1. The kind of the silica sol 4 is also the same as that in Example 1. However, the amount of the silica sol 4 was such that the weight ratio thereof to a total weight of the alumina short fibers 2 and aluminum borate particles 3 was about 0.07. Thus, the weight ratio of the silica particles contained in the silica sol 4 to the weight of the aluminum borate particles 3 is about 0.03. In the Comparative Example, the amount of the silica sol 4 is much smaller than that in Examples 1 and 2 according to the present invention.

After the mixing step, a dewatering step, a drying step and a sintering step are successively carried out in the same manner as that in Example 1 (see FIG. 1) to obtain the preform 61 (see FIG. 7). In the preform 61, pores of the aluminum borate particles 3 are exposed on the surface thereof. Namely, unlike Examples 1 and 2, the aluminum borate particles 3 are not covered in Comparative Example

In the preform 61, the adjacent alumina short fibers 2 and aluminum borate particles 3 are bonded to each other by crystallization of the silica sol 4 in the sintering step.

Using the thus prepared preform 61, the metal composite material 60 is formed by impregnation with a melt 6 of an aluminum alloy using the above-described die casting device 33 (see FIG. 2). The applied pressure for the impregnation of the melt 6 is the same as that in Example 1. The obtained metal composite material 60 is then subjected to cutting work using a milling machine to cut and polish the outer peripheral surface thereof, so that the cylindrical metal composite material 60 having the same dimension and shape as that of Example 1 is obtained.

The observation of the outer peripheral surface of the thus obtained metal composite material 60 of Comparative Example reveals that, as shown in FIG. 8(A), the exposed pores on the aluminum borate particles 3 are absent. This is apparent from the comparison with the metal composite material 10 (FIG. 5(A) of Example 1 and metal composite material 50 (FIG. 6(B)) of Example 2. Namely, as a result of the impregnation of the melt 6 under pressure, the melt 6 infiltrated into the pores which had been present in the preform 61 so that the pores of the aluminum borate particles 3 were filled inside therewith.

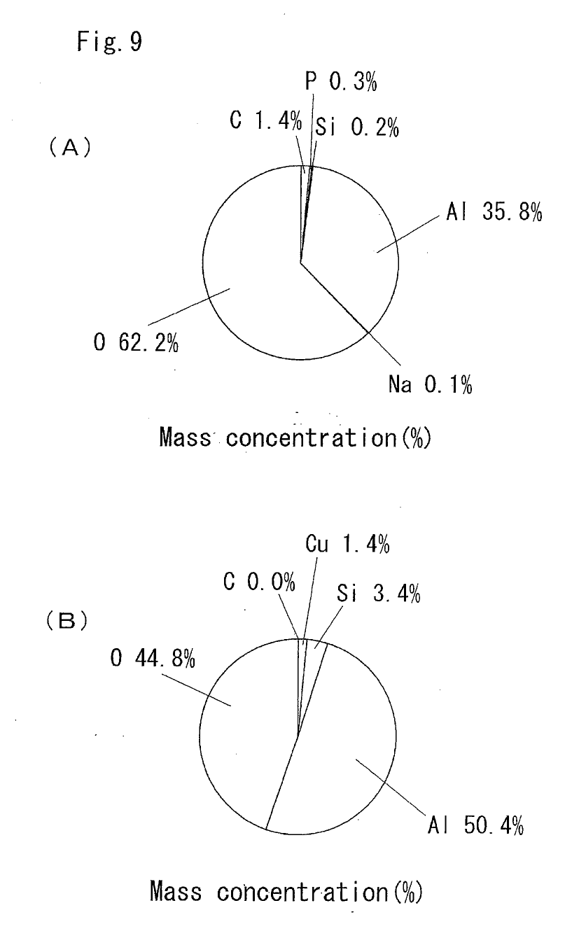

By comparing in detail the metal composite material 10 of Example 1 with metal composite material 60 of Comparative Example with respect to their aluminum borate particles 3 in a magnified state, it is evident that no aluminum alloy infiltrates into the aluminum borate particles 3 in the case of Example 1 as shown in FIG. 5(B), while the pores of the aluminum borate particles 3 are filled with the aluminum alloy in the case of Comparative Example as shown in FIG. 8(B). In each of the spectrum (analysis) ranges shown in FIGS. 5(B) and FIG. 8(B), mass concentrations of atoms were analyzed using an energy dispersion type X-ray analyzer. The results are shown in FIG. 9. The aluminum concentration of the metal composite material 10 of Example 1 (FIG. 9(A)) is lower than that of the metal composite material 50 of Comparative Example (FIG. 9(B)). It is thus understood that the aluminum alloy does not infiltrate into the aluminum borate particles 3. In the analysis, boron, which has a smaller atomic weight than that of carbon, cannot be detected. Therefore, no data for boron are given in the results.

No results of the atomic mass concentration analysis for Example 2 are described here. Because the aluminum borate particles 3 maintained in a porous form are exposed on the outer peripheral surface of the composite material, it is well expected that the results are similar to those of Example 1.

Test pieces having a predetermined dimension were cut out from the metal composite materials 10 and 50 of Examples 1 and 2 and from the metal composite material 60 of Comparative Example and were tested for their oil retention properties. Each of the test pieces has a rectangular surface with a dimension of 30 mm×40 mm cut from the outer peripheral surface of the corresponding composite material 10 or 50.

The oil retention property is measured as follows. An automobile engine oil (lubricating oil) is applied to the outer peripheral surface of each of the test pieces of Examples 1 and 2 and Comparative Example. The weights of each of the test pieces before and after the application of the oil are measured. After the application of the engine oil, each test piece is allowed to stand for 10 minutes and then the outer peripheral surface thereof is wiped with a cloth. Such wiping procedures are repeated until the measured weight becomes stabilized. From an increase of the weight calculated from the stabilized weight, which is an amount of the oil retained, the oil retention property is evaluated.

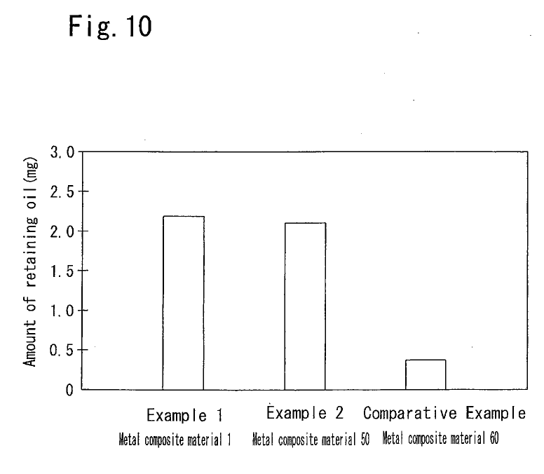

As shown in FIG. 10, the test results indicate that the test pieces cut out from the metal composite materials 10 and 50 of Examples 1 and 2 have extremely higher oil retention property as compared with the test piece cut out from the metal composite material 60 of Comparative Example. The reason for this is that the engine oil is absorbed and retained in the pores of the aluminum borate particles 3 exposed on the outer peripheral surfaces of the metal composite materials 10 and 50.

Comparative Example has been described above for the conventional technique in which the silica sol 4 was used. Results similar to those of Comparative Example are obtained when an alumina sol 5 is used in place of the silica sol 4.

As described in the foregoing, the metal composite materials 10 and 50 of Examples 1 and 2 can retain an oil within their aluminum borate particles 3 exposed on the outer peripheral surfaces thereof. Therefore, when they are used as a sliding member, excellent sliding properties can be achieved. Namely, when a desired sliding member is formed from a metal composite material 10 or 50 which is prepared in the same manner as that in Example 1 or 2 and when the sliding surface is cut and polished similar to the outer peripheral surface thereof, the obtained sliding member has a sliding surface on which the aluminum borate particles 3 maintained in a porous form are exposed.

The obtained sliding member is located at a desired position after, for example, a lubricating oil has been applied to the sliding surface. By this constitution, as the sliding member is slidingly moved, the lubricating oil oozes out from the aluminum borate particles 3 exposed on the sliding surface to form an oil film on the sliding surface. Therefore, the sliding member generally has improved wear resistance so that the sliding life through which the desired sliding property is maintained is prolonged and the durability is remarkably improved.

When a cylinder or piston of an engine, as a sliding member, is formed from the metal composite material 10 or 50 of Example 1 or 2, an engine oil is absorbed and retained in the aluminum borate particles 3 exposed on the sliding surface because the sliding member is slidingly moved in the engine oil. As the sliding movement is repeated, the engine oil retained within the aluminum borate particles 3 gradually oozes out. Therefore, even when the engine oil which is present around the sliding member is gradually deteriorated as the repetition of the sliding movement, the engine oil retained in the aluminum borate particles 3 gradually oozes out. Accordingly, wear of the sliding member can be suppressed. With the cylinder or piston formed from the metal composite material 10 or 50 having improved wear resistance, the sliding life through which the desired sliding property is maintained can be prolonged and the durability can be remarkably improved.

The present invention is not limited to the above-described embodiments. The embodiments and other constitutions may be properly changed within the scope of the gist of the present invention. For example, as the reinforcement, there may be used not only the alumina short fibers but also other short fibers, whiskers and particles (such as ceramic short fibers and ceramic particles).

1. A metal composite material comprising:
a metal base material molded by casting a molten metal, and
porous aluminum borate particles bound to the metal base material,
wherein said metal composite material having an outer surface on which aluminum borate particles maintained in a porous form are exposed.

2. The metal composite material according to claim 1, wherein the metal composite material is molded by impregnating a preform of sintered porous aluminum borate particles with the molten metal under pressure.

3. The metal composite material according to claim 1, wherein the porous aluminum borate particles are dispersed in the metal base material and wherein the outer surface has been polished so that the aluminum borate particles maintained in a porous form are exposed on the outer surface.

4. The metal composite material according to claim 1, wherein the porous aluminum borate particles have a particle diameter in the range of 3 to 100 μm.

5. A process for producing a metal composite material, comprising the steps of:
a mixing step of mixing together porous aluminum borate particles, a silica sol containing negatively charged silica particles and an alumina sol containing positively charged alumina particles in water to obtain an aqueous mixture slurry,
a dewatering step of removing water from the aqueous mixture slurry to form a preliminary mixture body,
a sintering step of sintering the preliminary mixture body at a predetermined temperature to form a preform,
a melt impregnation step of impregnating the preform with a molten metal by pressure casting, and
a grinding step of grinding an outer surface of the impregnated preform after the metal has been bound thereto.

6. The process for producing a metal composite material according to claim 5, wherein the silica sol is mixed in the mixing step in an amount so that a weight ratio of a total weight of the silica particles to a total weight of the aluminum borate particles is 0.01 or more and 0.30 or less, and the alumina sol is mixed in the mixing step in an amount so that a weight ratio of a total weight of the alumina particles to a total weight of the aluminum borate particles is 0.01 or more and 0.30 or less.

7. A process for producing a metal composite material, comprising the steps of:
a mixing step of mixing together porous aluminum borate particles, a cationic electrolyte solution containing a positively charged electrolyte and a silica sol containing negatively charged silica particles having a particle diameter in the range of 40 to 200 nm in water to obtain an aqueous mixture liquid,
a dewatering step of removing water from the aqueous mixture liquid to form a preliminary mixture body,
a sintering step of sintering the preliminary mixture body at a predetermined temperature to form a preform,
a melt impregnation step of impregnating the preform with a molten metal by pressure casting, and
a grinding step of grinding an outer surface of the impregnated preform after the metal has been bound thereto.

8. The process for producing a metal composite material according to claim 7, wherein the cationic electrolyte solution is mixed in an amount so that a hydrogen ion concentration pH thereof after having been mixed with the silica sol is 4.5 or higher and 8.0 or lower.

9. The process for producing a metal composite material according to claim 7, wherein the silica sol is mixed in the mixing step in an amount so that a weight ratio of a total weight of the silica particles to a total weight of the aluminum borate particles is 0.01 or more and 0.30 or less.

10. The process for producing a metal composite material according to claim 5, wherein the porous aluminum borate particles used in the mixing step have a particle diameter in the range of 3 to 100 μm.

11. The process for producing a metal composite material according to claim 5, wherein a polymer flocculant is added in the mixing step.

12. The process for producing a metal composite material according to claim 7, wherein the porous aluminum borate particles used in the mixing step have a particle diameter in the range of 3 to 100 μm.

13. The process for producing a metal composite material according to claim 7, wherein a polymer flocculant is added in the mixing step.
